(19) United States
(12) Patent Application Publication
(10) Pub. No.: US 2007/0107852 A1
(43) Pub. Date: May 17, 2007

(54) Retractable screen for interior doorway

(76) Inventor: Connie M. Gordon, Canton, CT (US)

Correspondence Address: LAW OFFICE OF STEVEN B. LEAVITT, L.L.P., P.O. BOX 537, ROWLETT, TX, 75030-0537, US

(21) Appl. No.: 11/271,233

(22) Filed: Nov. 12, 2005

(51) Int. Cl. E06B 9/08

(52) U.S. Cl. 160/23.1; 160/98

(57) ABSTRACT

The invention includes a detachable and retractable screen assembly for interior doorways of dwelling houses. The assembly includes a flexible sheet of screening material shaped to cover an open interior doorway of a dwelling, a moveable rod with the flexible sheet mounted thereto, removable attachment means for securely attaching the sheet mounted to the rod on an interior door jamb, and closure means for securing the assembly to an opposing interior door jamb, when the assembly is in use.

### BACKGROUND OF THE INVENTION

1. Technical Field

This invention relates generally to a detachable and retractable screen assembly which can be secured to a frame of an interior doorway and methods of using such assemblies.

2. Description of Related Art

Screen doorways are generally used for exterior doors to allow occupants of dwelling houses to leave their doors open for outside circulation. Screen doors have the advantage of allowing cooler air to circulate inside of the dwelling without running the air conditioner while keeping annoying pests such as mosquitoes, flies, bees and insects outside.

Interior doorways are generally not fitted with screen coverings, due to the fact that a typical screen covering would be cumbersome, expensive to install and difficult to disassemble should the occupants move from the dwelling. Also, if the occupant wants the air to circulate in a room, they can simply leave the door open. However, in some homes, such as those with infants or small children it is not safe to leave doors open. For example, most parents want to keep pets outside of an infant or child's room or parents may want to restrict a child's or pet's access to a room such as a home office or game room. Also, many parents want to be able to monitor their children while they are sleeping and would like to leave the door open.

Currently, the only method available to keep animals and/or children from entering a room without shutting the door is to install a gate in the doorway. However, most gates are not very sturdy and low in height. Often an animal can jump over the gate or a child or animal can cause the gate to fall allowing access to the room.

Interior screen door coverings could act as a barrier to keep pets out of children's bedrooms and still allow occupants to monitor their children and the air to circulate in the room. Such coverings could also be used to keep household pets out of any selected interior enclosed space.

Thus, a need exists for an apparatus and method of use for an interior screen assembly that addresses the aforementioned drawbacks.

### SUMMARY OF THE INVENTION

An aspect of the invention includes a detachable and retractable interior screen door assembly. The assembly includes a flexible sheet of screening material shaped to cover an open interior doorway of a dwelling. The flexible screen is made from polymeric material in a form which allows it to be retractable and rolled up for storage as well as unrolled for use. The screen is attached to one side of an interior door jam by removable attachment means that would allow the screen to be securely mounted to the door jam, yet easily removed by the occupant. The removable attachment means may include a shade roller on which the screen is mounted. The shade roller allows the screen to be pulled horizontally across the interior door opening when in use and retracted when not in use. The assembly also includes closure means on the side of the doorframe opposite to the side of attachment, to secure the screen during use.

A further aspect of the invention includes a method of using a detachable, retractable screen on an interior doorway of a dwelling. The method includes securing the screen to an interior doorframe with detachable attachment means, unrolling the screen to cover a doorway during use and securing the screen to the opposite side of the doorway with closure means.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a front view of an interior doorway with which an embodiment of the present invention is installed; and

FIG. 2 is a side view of an interior doorway depicting placement of the embodiment of FIG. 1.

### DETAILED DESCRIPTION

In the following detailed description, reference is made to the accompanying drawings that form a part hereof, and in which is shown by way of illustration, specific embodiments in which the invention may be practiced. These embodiments are described in sufficient detail to enable those skilled in the art to practice the invention, and it is to be understood that other embodiments may be utilized. It is also to be understood that structural, procedural and system changes may be made without departing from the spirit and scope of the present invention. The following detailed description is, therefore, not to be taken in a limiting sense, and the scope of the present invention is defined by the appended claims and their equivalents. For clarity of exposition, like features shown in the accompanying drawings are indicated with like reference numerals and similar features as shown in alternate embodiments in the drawings are indicated with similar reference numerals.

Briefly, an embodiment of the present invention includes a detachable and retractable screen door assembly for use on an interior doorway of a dwelling house.

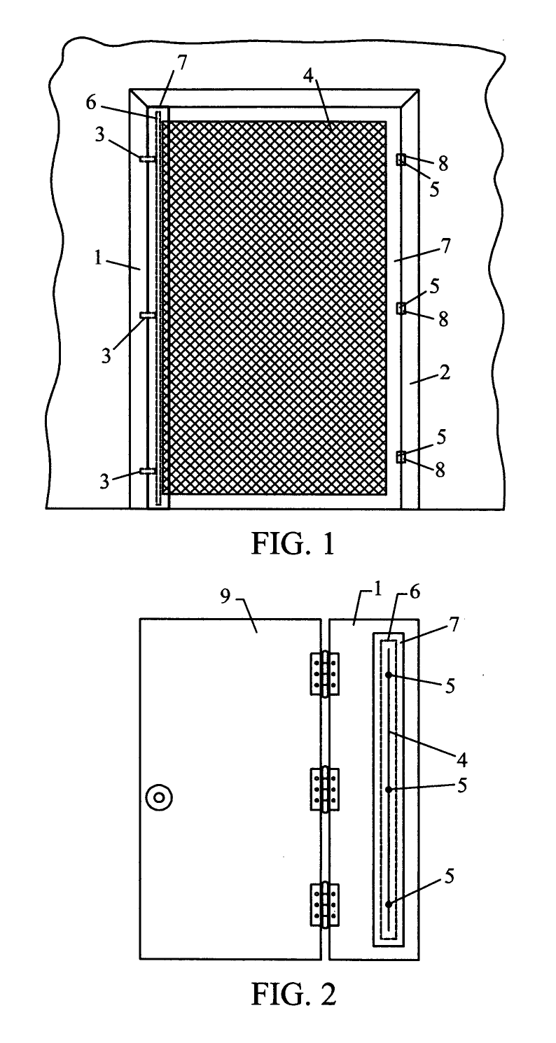

As shown in FIG. 1, the preset invention contains attachment means 3, screen 4, fastener 5, screen roller 6, screen housing 7, and mating fastener 8. Screen housing 7, contains screen roller 6, and at least a portion of screen 4. Screen housing 7 may be temporarily attached to left doorjamb 1 using attachment means 3. Examples of attachment means 3 include, but are not limited to screws, nails, bolts, adhesive, or some other attachments means for securing screen housing 7 to left door jam 1.

Left door jamb 1 and right door jamb 2 are merely for reference and may be alternated depending on the desired location of screen housing 7. For example, if it is desired that screen housing is located on right door jam 2, then attachment means 3 would also be located on right door jam 2. Screen housing 7 may be installed on the same side of the door frame as the door hinges or on the opposite side of the door frame.

When not in use, screen 4 is retracted and housed on screen roller 6 inside screen housing 7, as shown in FIG. 2. Screen 4 made from a mesh material such as nylon or fiberglass netting, or any other similar material know in the art that would allow for ventilation and screen 4 to be rolled or unrolled on screen roller 6.

Screen roller 6 is a device similar to a window shade roller such as those that are commercially available. As is known in the art, typical window shades have a shade roller that contains a spring held in tension by a bar that is often attached to a wall. When the shade is pulled down, the spring is put under increased tension. The attachment means connecting the bar to the wall holds the bar in a static position such that the spring tension keeps the shade in place. Then, when the shade is to be raised, the bar is moved from the static position such that the spring tension can be released thereby causing the shade to be raised. Such shade rollers typically include an opening to receive a shade.

In the present invention, screen roller 6 receives screen 4 and allows screen 4 to be retracted into screen housing 7 when not in use. When screen 4 is retracted into screen housing 7, at least one fastener 5 remains outside screen housing 7 such that fastener 5 can be used to assist in extending screen 4 from screen housing 7. In an alternate embodiment, screen housing 7 is replaced with shade roller holders which are commonly used when installing a window shade.

Fastener 5 can be virtually any type of fastening means known including, but not limited to, one part of a hook and eye attachment, one side of a cloth VELCRO® (hook and loop) fastener, or adhesive such as double sided mounting tape. If necessary, mating fastener 8 is the mating part of fastener 5. For example, if fastener 5 is the hook portion of a hook and eye attachment, then mating fastener 8 would be the eye portion. Also, if fastener 5 is adhesive such as double sided mounting tape, then mating fastener 8 would not be necessary.

When extended from left door jam 1 to right door jam 2, the tension from screen roller 6, fastener 5 and mating fastener 8 keep screen 4 securely tightened across the interior doorway. This advantageously allows monitoring of a small child during their sleeping hours and the circulation of air yet keeps household pets out of the child's rooms. It also allows the child to sleep undisturbed and still be monitored by parents or caregivers. The screen may also be used to keep pets and children out of selected areas of the dwelling house where the occupant may not wish to have their furniture, rugs or possessions damaged by pets.

An advantage of the invention is that it can be modified to fit any size interior doorway. Optimum dimensions of the screen will ultimately depend on the geometry of the particular interior doorway. The assembly can be manufactured to fit most common sizes of interior doors or custom ordered to fit doorways of non-custom sizes. Also, screen roller 6 may be used without screen housing 7 and such use would be obvious to those skilled in the art.

In one form, the assembly can be provided in a kit form which includes the screen 4 mounted to screen roller 6, screen housing 7, attachment means 3, and fastener 5 and mating fastener 8 such as cloth VELCRO® fasteners to provide selective attachment to an interior door frame.

The following illustrative example is intended to demonstrate certain aspects of the present invention. It is to be understood that this example should not be construed as limiting.

### EXAMPLE

By way of example, and not of limitation, a detachable and retractable screen door assembly was designed for an interior door of a dwelling house. The interior door consisted of two vertical opposing door jambs, left door jamb 1 and right door jamb 2 measuring approximately 7 feet in height and a top door jamb therebetween measuring approximately 5 feet in width.

Screen housing 7 was mounted to left door jamb 1 using attachment means 3 and placed at the top portion of the door frame adjacent to the top doorjamb and at the bottom portion of the door frame placed adjacent to the dwelling floor.

Screen housing 7 contained screen mesh netting 4 mounted on screen roller 6. Fastener 5 consisting of one side of cloth hook and loop fastener such as VELCRO® and were placed along the edge of screen 4 that was protruding from screen housing 7. Mating fastener 8 was the other side of the cloth VELCRO® fasteners and was placed and along right door jamb 2 to mate with fastener 5 and secure screen 4 when in use. Screen 4 operates by pulling it away from screen housing 7 to extend the width of the interior door frame and is fastened to the right door jamb 2 of the door frame by mating fastener 5 and mating fastener 8.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

What is claimed is:

1. A retractable screen assembly for interior doorways of dwelling houses, comprising:
a moveable rod;
a flexible sheet of screening material having a first end and a second end wherein the first end is attached to the moveable rod;
attachment means for securely attaching the moveable rod to a first interior door jamb; and
closure means for securing the second end of the screening material to a second interior door jam.

2. The screen assembly of claim 1 where the screening material is a polymeric material.

3. The screen assembly of claim 2 where the screening material is nylon netting.

4. The screen assembly of claim 2 where the screening material is fiberglass netting.

5. The screen assembly of claim 1 where the moveable rod is a window shade roller.

6. The screen assembly of claim 5 where the attachment means are window shade holders.

7. The screen assembly of claim 1 wherein the moveable rod is encased in a housing.

8. The screen assembly of claim 5 where the attachment means is at lest one screw.

9. The assembly of claim 1 where the closure means are selected from the group consisting of double sided tape, hook and eye fasteners, and cloth hook and loop fasteners.

10. A retractable screen assembly for interior doorways of dwelling houses, comprising:
a window shade roller;
a flexible sheet of screening material having a first end and a second end wherein the first end is attached to the window shade roller;
attachment means for securely attaching the window shade roller to a first interior door jamb such that the screening material may be extended from the first interior door jamb to a second interior doorjamb; and
closure means for securing the second end of the screening material to the second interior door jam.

11. The screen assembly of claim 10 where the screening material is a polymeric material.

12. The screen assembly of claim 11 where the screening material is nylon netting.

13. The screen assembly of claim 11 where the screening material is fiberglass netting.

14. The screen assembly of claim 10 where the attachment means are window shade holders.

15. The screen assembly of claim 10 where the closure means are selected from the group consisting of double sided tape, hook and eye fasteners, and cloth hook and loop fasteners.

16. A kit for providing a retractable and detachable doorway screening assembly for an interior doorway defined by a door frame having a top door jamb spaced above a floor and vertical door jambs extending from the floor to the top door jamb, thereby forming an enclosed area within an open doorway of a dwelling house, the kit comprising:
a window shade roller;
a flexible sheet of screening material having a first end and a second end wherein the first end is attached to the window shade roller;
shade holders for securely attaching the window shade roller to a first interior door jamb such that the screening material may be extended from the first interior door jamb to a second interior doorjamb; and
closure means for securing the second end of the screening material to the second interior door jam.

17. The kit of claim 16 where the screening material is a polymeric material.

18. The kit of claim 17 where the screening material is nylon netting.

19. The kit of claim 17 where the screening material is fiberglass netting.

20. The kit of claim 16 where the closure means are selected from the group consisting of double sided tape, hook and eye fasteners, and cloth hook and loop fasteners.
